(19) United States
(12) Patent Application Publication
(10) Pub. No.: US 2009/0144156 A1
(43) Pub. Date: Jun. 4, 2009

(54) METHOD OF ADVERTISING

(75) Inventors: Michael GIRGIS, Toronto (CA); Ian Robert GADSBY, Toronto (CA); Jake NEIMAN, Concord (CA); Dmitri MELEMAD, Toronto (CA); Daniel Joseph FRASER, Toronto (CA); Jeffrey David FINDLAY, Toronto (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: ONESTOP MEDIA GROUP, Toronto (CA)

(21) Appl. No.: 12/324,960

(22) Filed: Nov. 28, 2008

Related U.S. Application Data
(60) Provisional application No. 60/991,054, filed on Nov. 29, 2007.

(51) Int. Cl. G06Q 30/00; G06Q 90/00

(52) U.S. Cl. 705/14

(57) ABSTRACT

A retail establishment advertising system and method are disclosed. They allow a display of special content to interrupt a display of ongoing content on one or more display units. Ongoing content, such as advertisements, news, entertainment, or other relevant information, is provided on the display units until an urgent or security-related alert is required, and display of override content becomes necessary. Special content can include information relevant to specially discounted items or to security alert messages pertaining to, for example, security threats such as accidents, major delays, fire, missing children, terrorist activity, or other content deemed adequately pertinent to warrant interrupting the display of ongoing content.

### FIELD OF THE INVENTION

This application claims the benefit of U.S. Provisional Patent Application No. 60/991,054 filed on Nov. 29, 2007, which is incorporated herein by reference in its entirety. The present invention relates generally to automated display systems and to advertising on such systems. More particularly, the present invention relates to methods and systems for the control and management of electronic display systems in retail establishments.

### BACKGROUND OF THE INVENTION

There are a number of different dedicated media through which different content types, such as advertising, information and security messages are separately provided to customers in retail establishments. Such media include, for example, print advertisements, digital displays and auditory public address systems. The present media do not always succeed in capturing and maintaining a customer's attention because of their number and often blandness. Also, the presence of multiple media types can make it challenging to disseminate urgent security information due to competition between the different media for the customers' attention. Further, the cost of disseminating different content types from different content providers is high. Also, the maintenance and operation of separate communication systems is burdensome to the managers of retail spaces.

In-store specials are often advertised in flyers distributed at the entrance of a store, and/or announced on the store's public address system. Although customers are informed of items on sale, they are often not given the location of the items within the store. This can be frustrating to customers, specially in large multi-level department stores. Further, customers will often not read through the whole flyer or pay sufficient attention to the public address system to learn about other items that be of interest. This results in inefficient advertising and non-optimized sales.

Another problem is that of spouses or families shopping together. Spouses' shopping interests may not coincide, and an accompanying spouse may spend significant time in an area of the store in which he has little or no interest. This may curtail the other spouse's purchases in the store, resulting in lower sales and tension between spouses. Also, parents with accompanying children often have to hurry through shopping in order to keep the children from becoming restless, or one parent has to keep the children entertained while the other shops. This also leads to non-optimized sales.

Additionally, stores are often equipped with a security/emergency broadcast system, separate from any advertising system in place. This requires a duplication of maintenance and update tasks that result in higher capital and operational costs. Further, triggering present security/emergency systems, e.g. a fire alarm, usually results in sounding an alarm in the store and transmitting the alarm to a local emergency center for dispatching to an emergency response team. Other than the sound of the alarm, there is usually no information provided to customers of the store unless a separate public address system is used. Customers must locate the closest exit and evacuate the premises on their own, which can lead to undue stress for the customers.

It is, therefore, desirable to provide an adaptive retail signage and communication system capable of efficiently providing customer information and efficiently providing alarm/emergency remedies.

### SUMMARY OF THE INVENTION

It is an object of the present invention to obviate or mitigate at least one disadvantage of previous retail store advertising and communication systems.

According to one aspect of the present invention there is provided an in store content distribution system comprising: a processor in communication with an ongoing content source and a special content source, located at an advertising premise; a content controller for receiving a trigger signal and responsive to receipt to said trigger signal for sending instructions to the processor to process content from at least the special content source, a processing of content only from the ongoing content source or of content from at least the special content source, generating processed content; and a display controller in communication with the processor, the display controller being in communication with displays in the store and providing the processed content to the displays.

According to a further aspect of the present invention there is provided a method of advertising items in a retail establishment, the method comprising steps of: displaying a first item in a main portion of a display; displaying a second item in a preview portion of the display; and upon expiry of a pre-determined time period, replacing the first item with the second item.

According to another aspect of the present invention there is provided a method of advertising in a retail establishment, the method comprising steps of: displaying a first item in a main portion of a display; displaying a second item in a preview portion of the display; and effecting replacement of the first item by the second item by touching a touch-sensitive portion of the display.

According to a still further aspect of the present invention there is provided a method of advertising in a retail establishment, the method comprising steps of: displaying a first item in a main portion of a display; and displaying sponsored content in a secondary portion of the display.

According to another aspect of the present invention there is provided a method of advertising in a retail establishment, the method comprising steps of: displaying a first item in a first portion of a display located in a first section of the retail establishment, the first item available in the first section of the retail establishment; and displaying a second item in a second portion of the display in the first section of the store, the second item available in another section of the store.

According to a further aspect of the present invention there is provided a method of advertising in a first retail establishment, the method comprising steps of: displaying a first item in a first portion of a display located in the first retail establishment, the first item located in another retail establishment; and displaying a second item in a second portion of the display.

According to yet another aspect of the present invention there is provided a method of advertising in a retail establishment, the method comprising steps of: displaying a first item in a first portion of a display; displaying a second item in a second portion of the display; upon determination of an alert condition, reformatting the display to include an alert portion for displaying an alert message; and displaying the alert message in the alert portion.

According to a still further aspect of the present invention there is provided a method of advertising in a retail establishment, the method comprising steps of: monitoring the presence of customers in a section of the retail establishment; upon detecting the presence of a customer in the section of the retail establishment, displaying a first item in a main portion of a display; and displaying a second item in a preview portion of the display.

According to another aspect of the present invention there is provided a method of advertising in a retail establishment, the method comprising steps of: displaying a first item in a first portion of a display in communication with an advertising system; displaying a second item in a second portion of the display; receiving an override control signal at the advertising system; retrieving override content in response to the override control signal; formatting and transmitting override content to the display to interrupt displaying of at least one of the first item and the second item.

Other aspects and features of the present invention will become apparent to those ordinarily skilled in the art upon review of the following description of specific embodiments of the invention in conjunction with the accompanying figures.

Advantageously, certain embodiments of the invention permit a security alert to be broadcast both visually and audibly over the advertising system, without requiring maintenance of a separate, only occasionally-used, emergency communications system. By allowing an emergency message to override ongoing visual advertising, a customer's undivided attention is immediately drawn to the emergency message on a strategically placed display. In this way, maximum dissemination of emergency information can be realized.

As a further advantage, cost savings can be realized for the retail store authority or building management that incorporates the system according to the invention in place of separate systems for advertising, entertainment, security, customer information or emergency messaging. The simplicity of administering a single system in lieu of multiple parallel systems also offers the advantage of reduced personnel and associated costs.

According to specific embodiments of the invention that incorporate additional security features, such as integration with security devices, there is the added advantage that messages responsive to an alert or security threat can be provided as soon as detected, potentially averting undesirable situations.

### BRIEF DESCRIPTION OF THE DRAWINGS

Embodiments of the present invention will now be described, by way of example only, with reference to the attached Figures.

FIG. 1 shows a system according to an embodiment of the invention.

FIG. 2 is a schematic illustration of a display partitioned in three portions.

FIG. 3 is a flow chart of a method of advertising.

FIG. 4 shows a system according to an embodiment of the invention.

FIG. 5 shows a system in communication with a store's inventory system according to one embodiment of the invention.

### DETAILED DESCRIPTION

For the purpose of this description, the terms customers and clientele are used interchangeably. The terms department store, retail store, retail establishment and store are also used interchangeably. In the context of displaying an item on a display, the term “item” includes products, services, alerts, news, live video/audio feeds etc. The term “advertisement” can be any content intended to promote sales of a particular item, and can include, but is not limited to, a simple image of the item, produced vignettes involving the item, information about the item itself, and discounted pricing information for a particular item.

An embodiment of the invention provides a system and method that allows a display of special content to interrupt, modify or supplement a display of ongoing content. Ongoing content, such as advertisements, news, entertainment, or other relevant information, continues until the provision of override content becomes necessary. Special content can include information relevant to special promotions, discounted items or alert/alarm/emergency messages. For example, special content can include security alerts related to security threats such as accidents, major delays, fire, missing children, terrorist activity, or other content deemed adequately relevant to interrupt the display of ongoing content, as described in more detail below.

The system and method according to an embodiment of the invention offers the advantage that advertising feeds, television broadcasting, community messaging and emergency security broadcasts can be integrated into a single digital media management system, sharing consolidated infrastructure and display units. The system has all of the advantages of a conventional security alert system, while offering the additional advantage of revenue generation through advertisements and sponsored ongoing content. Such a system can replace conventional emergency messaging systems, such as public address systems, and advantageously allow emergency override control by a party such as a civic authority, building management, police or other centralized authority. As discussed in greater detail below, the system can optionally be sensitive to a store's inventory, or be in communication with a store's own inventory system, allowing advertising or other content to be selected based on information or conditions including, but not limited to, item stock and expiry dates. The redundancy between advertising systems and security alert systems can thus be eliminated.

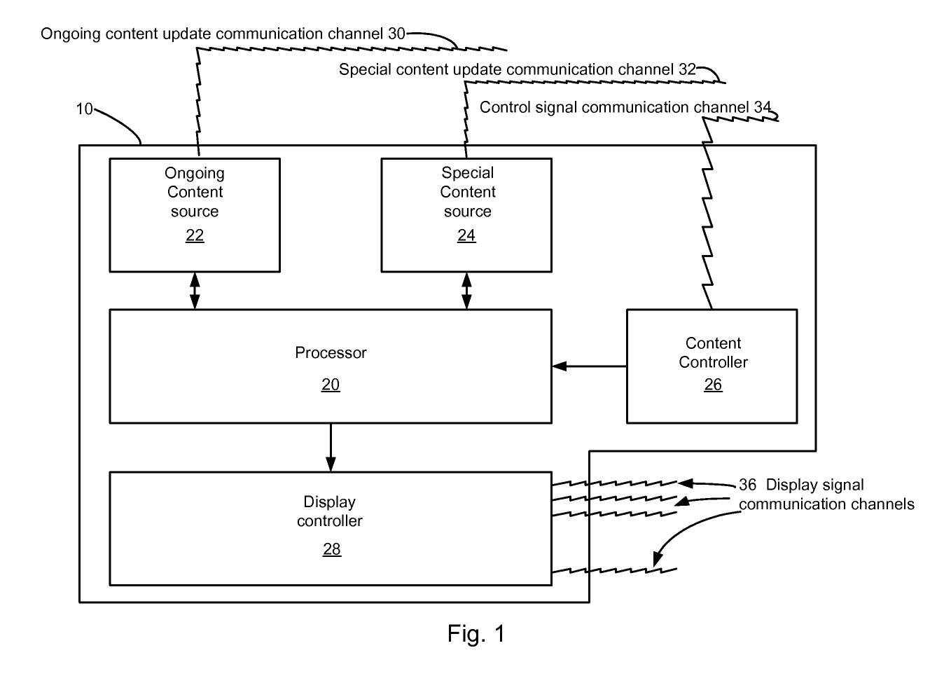

FIG. 1 schematically illustrates an in-store content distribution system 10 according to an embodiment of the invention. The system 10 includes a processor 20 and a content controller 26. The processor 20 is connected to at least one ongoing content source 22 and at least one special content source 24. The processor 20 can process content from the ongoing content source 22 and from the special content sources 24 and provide a processed content to a display controller 28, which disseminates, through display communication channels 36, display signals to displays (not shown) located in a store. All the communication channels disclosed herein, can be wireline or wireless communication channels.

The ongoing content source 22 can be updated by an ongoing content master source (not shown) though an ongoing content update communication channel 30 and the special content source 24 can be updated by special content master source (not shown) through a special content update communication channel 32. The processor 20, the content controller 26 and the display controller 28 can be embodied in any suitable general-purpose or specialized microprocessors. They can also be embodied in a single microprocessor. The ongoing content source 22 and the special content source 24 can be any type of storage means updatable through the update communication channels 30 and 32 respectively.

In ongoing mode, ongoing content is received at the processor 20, or retrieved by the processor 20, from the ongoing content source 22, processed by the processor 20 and provided to the display controller 28, which in turn provides display signal to the displays. The ongoing content can include, for example, pre-recorded advertisements, live feeds of ongoing telecasts, and scrolling text-based messages or tickers.

When a suitable control signal or trigger signal is received at the content controller 26 through the control signal communication channel 34, the processor 20 retrieves or receives special content from the special content source 24. The special content can include, for example, information on items greatly discounted, items discounted for a short time only, a message for a specific customer, a real-time source of information such as a live emergency broadcast, or a pre-recorded alert. The special content may also be directed to scenes or vignettes suggestive of items, the sales of which the store staff wishes to stimulate; for example, the display could show scenes of a family eating an ice cream cone on a hot day could to stimulate sales of ice cream or popsicles.

According to an embodiment, the trigger signal may also be received from a computer system or remote control operated by, for example, the staff of the store in which the system is deployed. In this manner, sales staff can control when special content is to be displayed to customer. For example, in a CD or music store where a staff member observes a customer with a shirt or other clothing bearing the logo of a particular band or musical group, and the special content source contains advertising content directed to that same group, the staff member can activate a trigger signal to initiate display of that special content to that particular customer.

The processor 20 then transmits a suitable signal to the display controller 28 to invoke an appropriate process for the display controller 28 to provide the special content to at least some of the displays located in the store. The special content provided to the display controller 28 by the processor 20 can generally take priority over any ongoing content, and be displayed over the entirety of a display or only on portions of the display. Thus the system 10 also allows for the dissemination of security messages and need not be viewed simply as an advertising expense.

The hardware parts of the system can be located remotely from the store in which advertising is provided. For example, the ongoing content source 22, the special content source 24, the processor 20 and the content controller 26 can be located at an advertising agency premise, while the display controller 28 is located in the store. Communication between the processor 20 and the display controller 28 can be through any suitable wireline or wireless technology. Of course, all other suitable combinations of hardware location are possible.

In an embodiment where the system is deployed in a mall, retail outlet or group of stores, content and/or a trigger signal may be received from a source controlled by the administrative authority of that group. This can allow an administrator to initiate the display of content in several stores simultaneously or provide information of a more general nature to customers. As one example of this embodiment, the retail centre may be hosting its own promotion or, such as the demonstration of a particular product or a particular exhibit which all customers in the retail centre can attend. The administrator can, through a computer system or any other signal-generating device, initiate special content related to the particular demonstration or exhibit in question.

A retail establishment can also use the system 10 to run advertisements of items available at the store itself or a commonly owned or operated store. For example, a hardware and automotive store can run advertising for its related work clothes store, thus improving cross-branding and sales. Further, the retail establishment can run advertising or sponsored content for other establishments, thereby generating revenue by sale of advertising space. Revenue-generating content can be provided in any acceptable format, and can be displayed across the entire display unit, or only a portion thereof. Advertising or sponsored content can be tailored to a particular demographic of individuals, or to a specific time of day. Revenue generating time-slots can be purchased by interested parties on a fee-per-unit-time basis, and adjusted to reflect the portion of the display unit used.

Ongoing content need not be advertising per se. Visual entertainment can be provided to achieve a desirable ambiance. For example, it may be desirable to display soothing scenes to calm tired customers, or provide trivia, sports score, or news feeds to amuse and inform customers such as, for example, waiting spouses and children. Such content could have revenue generation associated with it through a named sponsor.

The system of the present invention can incorporate any acceptable display unit to display content. For example, one or more television monitors, computer screens, or other type of digital display can be used as a display unit, the size and quality of which can be selected according to such parameters as space available, budget, and current infrastructure of the environment in which the display unit is to be installed. As exemplary types of display units, LED, plasma, LCD, rear projection, electronic flexible paper, light projection, touch screens or cathode ray tube based screens or monitors can be used. The display units can even be items carried for sale by the retail establishment.

Control of the ongoing content for the display unit can be done through a centralized ongoing content administrator. The ongoing content administrator can include individuals responsible for selecting items to advertise and for acquiring, or accessing, other types of ongoing content that they deem appropriate for customers of the retail establishment. For example, if the retail store is a linen store located in a shopping mall, an appropriate advertiser might be a spa located in the same shopping mall. Thus, the ongoing content administrator can solicit appropriate advertising content from the proprietor of the spa as ongoing content. Control of the ongoing content, and of the special content, can be automated through a website through which potential advertisers can select advertising options for their products. Maintaining such a website can be the responsibility of the ongoing content administrator.

Ongoing content and special content can be provided to the system 10 in any suitable way. An example of providing such content is through adaptive advertising as described in commonly-owned U.S. application Ser. No. 11/456,386, entitled “Adaptive Advertisements” and filed Jul. 10, 2006; U.S. application Ser. No. 11/613,467 filed Dec. 20, 2006, the entirety of which is herein incorporated by reference.

Briefly, the mode of implementation discussed in U.S. application Ser. No. 11/456,386 allows display of adaptive content, such as advertisements and promotions, through a communications system coupled with storage and processing facilities that can communicate with a central control system using a standard communications network, such as the Internet or suitable alternatives. The central control system includes a processor, an advertising database, and a transceiver for connecting to the communication system transceiver. The central control system can provide a playlist.

To provide adaptive content for display in the present system, system 10, an adaptive advertising structure as taught in U.S. application Ser. No. 11/456,386 can be used. For example, the ongoing content source 22 and the special content source 24 can include inputs, such as time of day, date or weather, for use in adaptive advertisement and, on the basis of the inputs, playback scenarios and ongoing or special content can be adapted and displayed. The playback scenarios can be located in a playlist (not shown) in communication with the processor 20, the playlist essentially acting as an ongoing or special content source.

In the case where the playlist acts as an ongoing or special content source, the processor 20 reads the playlist and processes and/or renders content of the playlist to be displayed. The playlist can optionally include an adaptive advertisement. Should the processor 20 receive an adaptive advertisement from the playlist, it provides a set of input values to the adaptive advertisement, the set of inputs being provided by one or more ongoing content source 22 or by dedicated inputs (not shown) connected to the processor 20. The processor 20 can provide all the inputs it receives to the adaptive advertisement, allowing the advertisement to determine which inputs are relevant, or can obtain a list of required inputs from the advertisement and then provide only those inputs to the advertisement.

As described in U.S. application Ser. No. 11/456,386, an adaptive advertisement can be embodied in a software or data structure that includes a decision engine, and a plurality of playback scenarios. These playback scenarios can be either major or minor changes to an advertisement. An advertisement can be made modular, so that it can be rendered against a number of different backgrounds. In such a case, the different backgrounds can be selected as different playback scenarios. In other cases, text displayed in the advertisement can be made modular, allowing different messages to be treated as different scenarios. Other elements in an advertisement, such as video, animations and a price point can all be considered as different playback scenarios.

When the decision engine determines the playback scenario, and provides content to be rendered, the content can be in any one of a number of formats. Content can be provided as an extensible mark-up language (XML) data structure that can contain, text, video, and animations. The XML data structure is then rendered by the processor onto a display unit. The processor can include a Macromedia Flash™ rendering engine that can combine animation, text and video into an integrated advertisement. One skilled in the art will appreciate that any number of other rendering engines can be used, and that the invention is in no way limited to the use of Flash rendering engines.

In an alternative embodiment, individually created advertising content elements are stored in an advertising database (not shown) with a set of associated criteria, the database being connected to the processor 20. The processor 20 is provided with a playlist, that provides criteria for the selection of content stored in the advertising database. The processor 20 can evaluate the received inputs in view of the specified criteria, including the last time that a particular advertisement played, and can determine the advertisement to select from the advertising database. The selected content is then processed and/or rendered by the processor 20 and subsequently displayed.

The display controller 28 can provide different display signals to different displays, i.e., each display can receive its own processed or rendered data stream. The location of a display can also be used to determine the selection of scenarios for use in the adaptive advertising, allowing advertisers to create advertisements that indicate the presence of a particular product or service in the vicinity of the display unit. Weather forecasts, including UV ratings, humidity indices, and extreme weather warnings, can be used as inputs to determine a particular playback scenario that a store can wish to display, allowing for example a department store to advertise umbrellas when the weather calls for rain and sunblock when the UV rating is high.

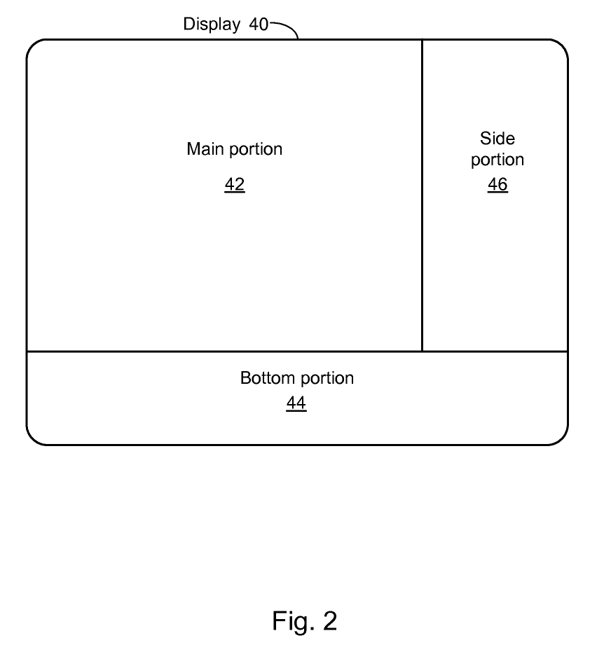

Each display connected to the system 10 can have multiple display portions to display multiple messages or advertise multiple products simultaneously. FIG. 2 illustrates such a display 40 with a main portion 42, a bottom portion 44 and a side portion 46. The content from each of the main portion 42, the bottom portion 44 and the side portion 46 can originate from a single or from multiple instances ongoing content source 22, from a single of from multiple special content source 24, or from ongoing content sources and special content sources. Although not shown here, the display 40 can be made up of a plurality of separate, adjacent monitors. Each monitor can be treated as a separate region, or content can be displayed on a region that traverses more than one adjacent monitor or region. Regions can be stacked horizontally or vertically, or can appear as a mosaic.

Multiple display regions on the display 40 can achieve different objectives at the same time. The objectives can include, for example, increase sales through own product adverts, revenue generation through third party advertisement, entertainment of the clients through trivia, vignettes and/or sports scores, communication of stores hours, and location of nearby store departments and washrooms. The benefit of having trivia, vignettes and/or sports scores on the display is that waiting parties such as, for example, an accompanying spouse or children can be kept entertained by the display. Additionally, items from another department that might interest the waiting parties can be displayed, thereby potentially increasing sales of the store.

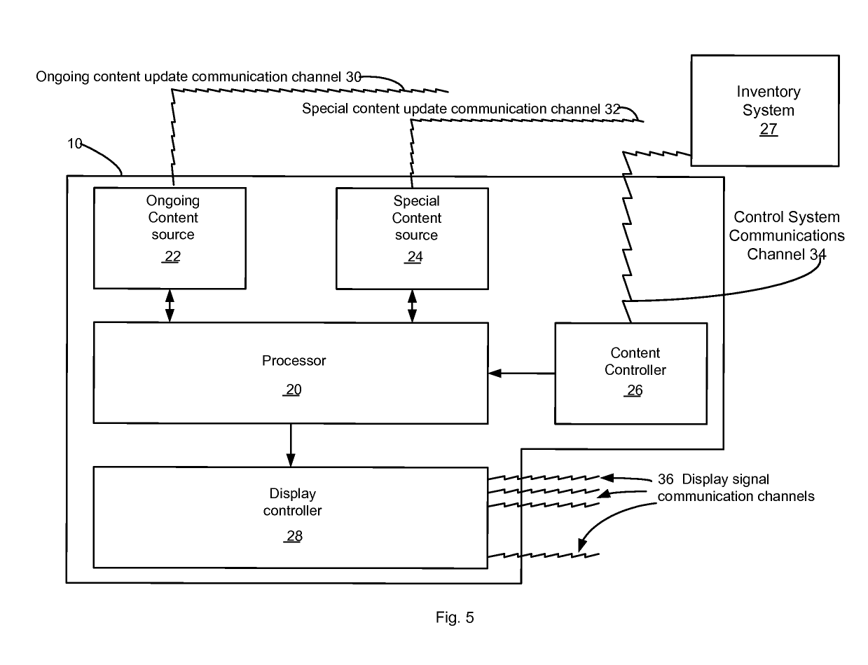

As an advertising example, the display 40 can include a main portion displaying a main advertisement for an item with details such as, the location, the price, the discount, the discount expiry date and instructions on how to use the item, and a preview portion where one or more preview items are displayed with limited details, if any, the preview items to be displayed momentarily, one at a time, in the main portion with all their relevant details. In an embodiment where the system is in communication with a store's inventory system as shown in FIG. 5 and discussed below, the items can be selected based on information received from the inventory system. For example, the item displayed in either the preview portion, the main portion or both portions of the display can be selected based on the items' respective expiry dates as stored in the inventory system. In this manner, a retailer can stimulate sales of those items prior to their expiry dates and thereby reduce waste.

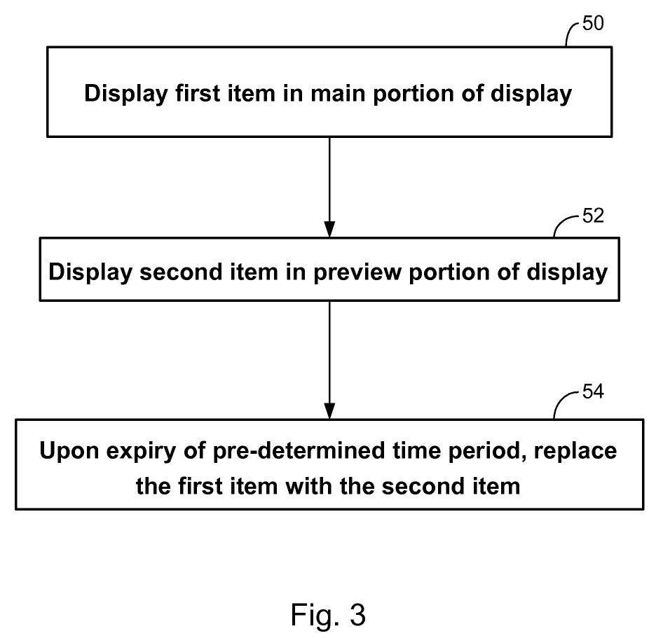

The preview items to appear in the preview window can be selected based on percentage discount or by other categories. As an example, the preview items can be organized by the time before display in the main portion in order to inform a customer of the time at which a preview item of interest will appear in the main portion with all its relevant details. In this case, say each advertisement is displayed in the main portion of the display for 15 seconds and there are four items in the preview portion, each preview item can have an associated countdown timer starting at 15, 30, 45 and 60 seconds respectively. Other categories in which preview items can be organized can also include similar items categories such as jackets, pants, shoes, etc. Loyalty program information items can also form a preview category. A simple example illustrating such a method of advertising is shown in FIG. 3 where steps of displaying a first item in a main portion of a display and displaying a second item in a preview portion of the display are shown at reference numerals 50 and 52. Step 54 shows that the first item in the main portion is replaced by the second item at the expiration of a pre-determined time period. The preview portion can be akin to a ticker showing multiple preview items simultaneously.

In the case where the display 40 is a touch screen, a customer can touch an icon or thumbnail on the screen, within the preview section, to advance the item related to the icon or thumbnail in the rotation to have the item displayed, together with its full details, in the main portion of the display.

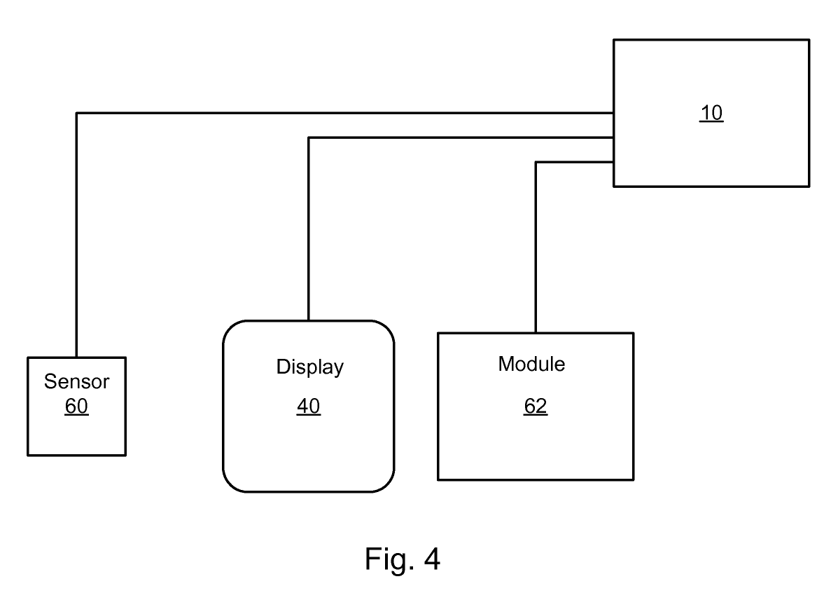

Additionally, as shown in FIG. 4, a motion sensor 60 disposed in a particular department of the store can be coupled to the system 10 to signal the system, upon detection of a customer entering the department, to commence an item display rotation in that particular department.

The system 10 need not be restricted to “preview” mode to display more than one advertisement at one particular time. According to one embodiment of the invention, a display can be formatted to display advertisements relating to two distinct items that are available in the store or elsewhere. The items can be related; for example, one portion of the display can show content directed to a pair of running shoes available in the store, while a second portion of the display can simultaneously show content directed to a pair of athletic socks also sold by the retailer. As one example of an embodiment of the invention where the items are unrelated, one portion of the display can show content directed to ladies' shoes, while a second portion can show content directed to men's watches. In this manner, the retailer can provide content that interests shoppers with different interests simultaneously.

The system 10 can also be provided with modules, such as module 62 shown in FIG. 4, for presenting additional information to clients and/or for obtaining information from clients. The module 62 can be an input device, e.g. a touch screen, where a customer enters a mobile device, for example a cell phone, number to receive short message service (SMS) notifications from the store in regards to items on sale or special promotions. As a further example, the module 62 can be a printing module connected to the system 10 to provide electronic coupons or additional/peripheral information to the customer.

The system 10 can also provide content that is particular to certain departments or zones within stores. For example, in a hardware store, the content on the displays in the plumbing department can appeal to the shopper in that section, while the displays in the power tools department can have a display appropriate for that section. Further, the displays in a given section can be integrated with the inventory systems of a different section to generate sales up-lift in the different section.

The system of the present invention can also be used in the off hours of the store. In this case, the displays 40 can be used for human resources messaging, training, instructing, displaying employee incentives, general announcements, etc. Of course, as mentioned earlier, during revenue hours, the displays can be used as a communication channel with the customer for product advertisement, sales information, store hours, community support services (e.g., not for profit messaging, sponsorship of local teams, etc.), revenue source for vendors and third parties to promote their wares, and loyalty programs information.

The system of the present invention can provide automated messages and is integrable with points of sales to display timely information and alerts (whether full screen or not) based on pre-programmed parameters.

In a further embodiment of the invention, the system 10 can track the inventory and expiry dates of store items, or can be in communication with a store's own inventory system 27, as shown in FIG. 5. In this manner, the content can depend on information received from the inventory system. As an example, the inventory system 27 can indicate to the system 10 where the store has an excessive stock of one particular item. The content controller can then activate advertising content directed to the specific item. For example, a clothing retailer that inadvertently receives an excessive shipment of a particular brand of shoe may decide to sell the excess volume rather than going through the hassle of shipping it back to the manufacturer. The retailer can then initiate a special advertising campaign by activating special content directed to that shoes held in overstock so as to stimulate sales.

In another example, the system can track expiry dates of store items, and can automatically promote a product close to its expiry date (e.g. milk). As the date approaches, the system can display special content directed to advertisements for the product whose expiry date approaches or notifications to customers of a reduction in price of the items. Pricing can continue to decrease automatically on the displays, based on a pre-programmed formula that continues to reduce the price based on time to expiry and/or on the number of items in stock.

The system may also be sensitive to the store's stock in relation to the current season. As an example, a clothing retailer that sells seasonal apparel adorned with Christmas or other holiday symbolism may wish to stimulate sales of these specific items as the holiday season reaches a close. As the end of the month of December approaches, the content controller 26 can initiate special content directed to advertising the holiday items.

The system of the present invention can be programmed to update automatically a price database used by the store's points of sales, and inventory related messages can be uploaded in an ongoing content source 22, or in a special content source 24 to be displayed as an alert-type message.

The system of the present invention can be also used to display several type of alarms relevant to customer in the store. These alerts include, amongst others, store renovation information, fire alarms, alarms integrated with public organizations (e.g. Crime Stoppers, Amber Alert, Homeland Security), severe weather alerts and warnings, etc. Thus, the system of the present invention can be seen as a safety and security (S&S) communication system that achieves store messaging and revenue objectives when the S&S communication system is not required.

The following illustrates how the present system can be used to integrate advertising and alert/emergency functions. Most retail stores are provided with closed circuit cable television (CCTV) used as a deterrent for theft. The CCTV monitors typically use full screen displays. The system of the present invention allows to shrink the CCTV feed to only a portion of the display and to add advertising content around this portion. Therefore, the system of the present invention allows revenue generation by providing advertising content to the CCTV display.

As will by understood by workers skilled in the art, the system of the present invention can thus provide content management tools to the retail store's staff and management, to the regional management of the chain of retail store, to the head office, to authorized suppliers, etc. Such content management tools includes, for example, any means suitable to interact with the master ongoing content and special content sources, with the ongoing content source 20, with the special content source 22, with the processor 20 and/or with the content controller 26.

With respect to urgent messages, a signal to override the ongoing content with an urgent message can be provided by an automated system, or can be manually activated. A signal invoking special content can be received at the processor controller 26 based on data inputs from an integrated device, such as discussed in more detail below, or can be automated on the basis of a specialized signal received from a local, regional or national authority, such as the local police, fire department, or the Department of Homeland Security. A manual override signal can be provided at the instigation of an individual responsible for determining the urgency of a situation or the severity of a security breach.

By allowing urgent special content to interrupt ongoing content, there is benefit realized due to the consolidation of infrastructure for advertising and for security systems that were heretofore administered and maintained as separate entities. Special content can pre-empt ongoing advertising content if it is deemed important for the clientele within the vicinity of the display unit. Control of special content can be centralized, for example through centralized service such as, for example, the ongoing content administrator, responsible for the control of ongoing advertising content and the retail establishment authority that has incorporated the display units into their store.

Control of special content can alternatively be de-centralized, or multiple parties can be provided with special control abilities. Exemplary multiple parties can include the retail store authority, the ongoing content administrator, the police, a national or regional authority, such as the Department of Homeland Security, or an authority responsible for early alerts relating to missing children (i.e. “Amber” alerts). The ability to interrupt ongoing advertising content with special content can be simultaneously attributed to numerous parties. Advantageously, by including a number of parties in an exclusive list of special content providers, urgent warnings or messages can be rapidly disseminated to the clientele of the retail establishment.

In some instances, it can be desirable to centralize the control of special content, so that only one party determines whether an urgent situation is one that warrants interruption of ongoing content. For instance, the retail establishment authority can wish to exert central control over special content so that non-urgent messages can be screened out, to avoid unnecessary panic among customers. In this example, parties having an urgent message which may be of interest to customers would first contact the system authority who would make the determination of how and whether to provide the urgent message to the customers.

In many instances, it may be desirable to interrupt all ongoing content on all regions of a display unit to provide special content. However, depending on the level of urgency or the length of time that the special content may be displayed, it may not be desirable to occlude all regions of the display. For example, if a missing child is reported, a photograph of the child could be deemed adequately important to display for a lengthy period of time, or until the child is found. In this instance, and depending on the size and aspect ratio of the display unit, the child's photograph could be displayed constantly on one half of the display unit, while ongoing content continues in the other half of the display unit. Combining special content with ongoing content has the added advantage of maintaining the attention of the customers. If a photograph of a missing child is the only content displayed for a lengthy period of time, even the most sympathetic of customers can nevertheless become complacent, or tire of seeing only the image of the missing child. However, by attracting the attention of the customers to the display unit through changes in the ongoing content, the attention of the customers to the display unit is held.

Weather warnings are another exemplary type of special content that can be provided by the system. For example, if a hurricane or other type of severe weather approaches, an appropriate safety agency can cause interruption of ongoing content and issue an alert to advise customers of the imminent weather danger. Optionally, the authority responsible for issuing weather advisories can advise a central administrator of the system, which would in turn trigger an automated or manual override of ongoing content.

The system of the present invention can also be used to alert the public to an imminent terrorism-related threat or to terrorist activity in progress. For example, if a bomb threat has issued to the retail store or its vicinity, special content can interrupt ongoing content to prompt evacuation and advise of the suspected location, and to direct the public away from the suspected target region. As an additional example, if a suspicious package is discovered in a retail establishment, and evacuation is deemed appropriate, override of ongoing content can be used to assist the retail establishment management to disseminate appropriate instructions and messages to the clientele.

Thus, in the event that an urgent situation arises the override function of the system 10 allows for quick notification to the customers. Further, manual and/or automatic control of override content can reside with one or more parties, such as the retail establishment management, police and fire departments, or parties external to the retail establishment management who may have responsibility for one or more feeds of ongoing content.

The system 10 can optionally integrate with other security devices in order to respond to a situation, provide instructions, negate undesirable activity, or provide interactive communication capabilities. Such adjunct security devices can be automatically or manually integrated with the system to provide special content, or can function on an ongoing basis using the infrastructure of the system 10. Such security devices can include surveillance cameras, motion sensors, proximity detectors, global positioning systems, fire alarms, GPS devices, or panic buttons. These security devices can be capable of exerting control over and/or providing content to the special content source 24, or can simply provide content to the ongoing content source. Cameras and all other integrated security devices can use the same or different technology and communication infrastructure as used by the display units (for example, local area networks or the Internet). Further, integrated security systems can be used to send data back to the system for manual or automated review, analysis, or other operations. In essence, by providing feedback to the system, such integrated security devices can provide a real-time, interactive process, whereby output can be made responsive to input.

The system 10 and any device integrated into the system can be configured so as to act together in providing a two-way emergency communications channel. When a surveillance camera is integrated with the system 10, should a problem be detected within a particular store department, the surveillance camera and display unit can act together to provide a two-way communication between the clientele and a remotely located party, such as the police or the retail establishment authority.

As an additional example of how the system of the present invention can be used, a fire alarm can be integrated with the system. For customers in a particular area of a retail establishment where a fire erupts, anxiety and panic can set in quickly. In order to alert the individuals within that area with information provided by the retail store management, urgent messages can be provided immediately once the fire alarm is received. Such messages may be a standard pre-recorded message simply to encourage passengers to remain calm until such time as more information is available, or a tailored message can be provided in real-time, indicating the best escape route. By integrating the system 10 with a fire alarm device, an immediate urgent message can be relayed without requiring specific intervention by an override or ongoing content administrator. A specific message can be relayed shortly after the pre-recorded message, giving information about which floor received the call about the fire, instructions for assistance, or anticipated time until arrival of the fire department.

The system 10 is dynamic in terms of capabilities. The content can include dynamic display content such as video and animation, as well as stationary graphics or text-based messages which can scroll or remain static. The display can additionally include an audible component corresponding to, complimentary to, or separate from the visible display content. The size and positioning of the partitioned regions can be defined either statically or dynamically. In some embodiments, partitioned regions can be defined as static, while other regions are dynamic. The system can also handle a live video broadcast.

The system can receive a plurality of inputs from, for example, the ongoing content source 22, the special content source 24, the sensor 60 and the module 62. Content displayed on the display unit can be selected from the received inputs, or can be derived from a pre-existing stored digital media. Not all of the inputs need be active at the same time, nor does the system need to be constantly connected to the input sources.

In one exemplary embodiment, the inputs can be provided in a format that can be encapsulated in an XML or Flash data stream, so that the system can make use of standard XML decoding methods, and Flash/Actionscript front end elements to render information on the display unit. Each region of a display unit can be treated by a rendering engine in the system as a separate display that will be provided its own XML and Flash-based data stream to render. Input formats can vary, and are not limited to this example.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

In the preceding description, for purposes of explanation, numerous details are set forth in order to provide a thorough understanding of the embodiments of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

The above-described embodiments of the present invention are intended to be examples only. Alterations, modifications and variations can be effected to the particular embodiments by those of skill in the art without departing from the scope of the invention, which is defined solely by the claims appended hereto.

What is claimed is:

1. An in store content distribution system comprising:
a processor in communication with an ongoing content source and a special content source, located at an advertising premise;
a content controller for receiving a trigger signal and responsive to receipt to said trigger signal for sending instructions to the processor to process content from at least the special content source, a processing of content only from the ongoing content source or of content from at least the special content source, generating processed content; and
a display controller in communication with the processor, the display controller being in communication with displays in the store and providing the processed content to the displays.

2. The system as claimed in claim 1 wherein, the processed content includes a first processed content portion and a second processed content portion, the display controller for providing the first processed content portion to a first subset of displays and the second processed content portion to a second subset of displays.

3. The system as claimed in claim 1 wherein, the processed content includes a first display zone processed content and a second display zone processed content, the first display zone processed content to be displayed in a first zone of at least one of the displays and the second display zone processed content to be displayed in a second zone of the at least one of the displays.

4. The system as claimed in claim 1 wherein, the processed content is advertising content.

5. The system as claimed in claim 4 further comprising a sensor to be activated by a customer, the sensor located in a vicinity of at least one of the displays, an activation of the sensor initiating display of the advertising content on the at least one of the displays.

6. The system as claimed in claim 4 wherein, at least one of the displays is an interactive display for interaction with a customer, the customer interacting with the display causing the advertising content to be displayed on the at least one of the displayed in accordance with a pre-determined sequence.

7. The system as claimed in claim 1 further comprising an interactive module to interact between the system and a customer, an operation of the interactive module by the customer resulting in at least one of providing information to the customer and providing customer information to the system.

8. The system of claim 1 wherein, the ongoing content source includes advertising content and the special content source includes at least one of special advertising content and alarm content.

9. The system of claim 8 wherein, the trigger signal is an alarm control signal and the processed content includes the alarm content.

10. The system of claim 8 wherein, the trigger signal is from an inventory control system and the processed content includes special advertising content dependent on the state of said inventory control system.

11. The system of claim 1 wherein the processor is located at an advertising premise remote from said store.

12. A method of advertising in a retail establishment, the method comprising steps of:
displaying a first advertisement in a main portion of a display;
displaying a preview of a second advertisement in a preview portion of the display; and
upon occurrence of an event, replacing the first advertisement with the second advertisement.

13. The method of claim 12 wherein, the event comprises expiry of a pre-determined time period.

14. The method of claim 12 wherein, the event comprises a touching of a touch-sensitive portion of the display.

15. The method of claim 12 wherein, the advertisements are selected based on input from an inventory system.

16. The method of claim 12 wherein, the second advertisement comprises sponsored content.

17. The method of claim 16 wherein, the sponsored content comprises at least one of trivia, news, sports scores, a vignette and an alert message.

18. A method of advertising in a retail establishment, the method comprising steps of:
displaying a first advertisement relating to a first item available in the retail establishment in a first portion of a display located in the retail establishment; and
displaying a second advertisement relating to a second item available in the retail establishment in a second portion of the display.

19. The method of claim 18 wherein, at least one of the first advertisement and the second advertisement are selected based on the current date.

20. The method of claim 18 wherein, at least one of the first advertisement and the second advertisement are selected based on information from an inventory control system.

21. The method of claim 20 wherein, the information from said inventory control system comprises expiry date information.

22. The method of claim 20 wherein, the information from said inventory control system comprises inventory quantity information.

23. The method of claim 18, further comprising the steps of:
upon determination of an alert condition, reformatting the display to include an alert portion for displaying an alert message; and
displaying the alert message in the alert portion.

24. The method of claim 23 wherein, the alert message is a security alert message.

25. The method of claim 23 wherein, at least one of the alert condition and the alert message are based on information received from an inventory control system.

26. The method of claim 18 wherein, the alert message is a discount message.

27. The method of claim 26 wherein, the discount message includes a discounted price for an item, and the discounted price being correlated to an expiry date of the item.

28. The method of claim 26 wherein, the discount message includes a discounted price for an item, the discounted price being correlated to an inventory of the item.

29. A method of advertising in a retail establishment, the method comprising steps of:
displaying a first advertisement relating to a first item in a first portion of a display in communication with an advertising system;
displaying a second advertisement relating to a second item in a second portion of the display;
receiving an override control signal at the advertising system;
retrieving override content in response to the override control signal;
formatting and transmitting override content to the display to interrupt displaying of at least one of the first advertisement and the second advertisement.
